(19) United States
(12) Patent Application Publication
(10) Pub. No.: US 2008/0224416 A1
(43) Pub. Date: Sep. 18, 2008

(54) SPLIT MECHANICAL SEAL

(76) Inventor: Christopher J. Carmody, Doncaster (GB)

Correspondence Address: EDWIN D. SCHINDLER, FIVE HIRSCH AVENUE, P.O. BOX 966, CORAM, NY, 11727-0966, US

(21) Appl. No.: 12/048,965

(22) Filed: Mar. 14, 2008

(30) Foreign Application Priority Data
Mar. 14, 2007 (GB) 0704855.6

(51) Int. Cl. F16J 15/34

(52) U.S. Cl. 277/399

(57) ABSTRACT

A seal face ring for use with a split mechanical seal, the ring having diametrically opposed grooves along at least a portion of the surface of the ring. The grooves provide lines of weakness for splitting the ring segmentally and are inclined relative to each other.

### BACKGROUND OF THE INVENTION

1. Technical Field of the Invention

This invention relates to split mechanical seals.

2. Description of the Prior Art

A mechanical seal is a device which is used to prevent fluid leakage from equipment which has a fixed cavity, containing the fluid, and a rotatable shaft. In practice, such a seal is usually situated at the point where the rotatable shaft enters (or leaves) the stationary part of the equipment. Rotary mixers, agitators and pumping devices are typical examples of the type of equipment in which a mechanical seal might be used.

Mechanical seals comprise two distinctly separate sets of components, those which rotate with the shaft of the equipment on which the seal is mounted (the rotary parts) and those which are fixed relative to the stationary equipment body (the stationery part). The interface between these two sets of components comprises two contacting seal faces, a rotary and a stationery face. These faces are normally manufactured to precise, very accurate standards.

In order for a mechanical seal to function correctly, the two seal faces must be kept in constant contact with one another. To achieve this, it is usual for a seal to include one or more springs, which act as biasing means to urge the seal faces together. In a “stationery type” seal, the spring or springs act against the stationery seal face to urge it towards the rotary face. In a “rotary type” seal, the spring or springs act against the rotary face to urge it towards the stationery face.

Repair or replacement of parts of mechanical seals is difficult whenever inaccessibility of the outboard end of the shaft or the location of the machine makes it impossible to slip the seal off the end of the shaft. In such situations, the machines themselves must be disassembled.

This difficulty is overcome by splitting the sealing rings and other seal parts radially into two or more parts so that each ring may be removed from, and new rings reassembled within, the seal and about the shaft.

U.S. Pat. No. 3,101,200 describes a mechanical seal in which the relatively rotatable seal rings are each sectionalised in the sense they are divided circumferentially into a plurality of sectors.

Such split rings are manufactured, typically, by cutting a whole ring into two segments. With such cut rings, the cut faces of one ring segment are precisely lapped while discarding the other ring segment and mating the one segment with a segment from another whole ring, similarly machined, so as to form a segmented ring of the same dimensions as a whole ring.

Broken rings are also known in which the irregular broken surfaces permits self matching of the ring halves without lapping.

Where the grain structure of the ring is relatively coarse, such as provided by a carbon ring, the diametric breaking of the ring, usually about oppositely aligned diametric grooves, results in sufficiently irregular broken surfaces which enable the ring segments to be brought together accurately because of the keying effect of these rough surfaces.

However, in the case where the grade structure is relatively fine, the broken surfaces tend not to be capable of keying together particularly accurately and there can be misalignment between the ring segments when the ring is reassembled.

### SUMMARY OF THE INVENTION

According to the present invention there is provided a seal face ring for use with a split mechanical seal, the ring having diametrically opposed grooves along at least a portion of the surface of the ring, said grooves providing line of weakness for splitting the ring segmentally, said grooves being inclined relative to each other.

Preferably, said inclination is in a longitudinal direction.

Preferably, said grooves are inclined relative to the longitudinal axis of said ring.

Preferably, there are two grooves so that splitting the rings segmentally produces two half rings.

Preferably, said grooves are inclined in opposite directions relative to said longitudinal axis.

Preferably, said grooves extend along at least an inner circumferential surface of said ring.

Preferably, each said groove is inclined at an angle of up to 10° relative to the longitudinal axis. More preferably, if each said groove is inclined at an angle of up to 5° relative to the longitudinal axis. Most preferably, each said groove is inclined at an angle of at least 2.5° relative to the longitudinal axis.

By providing lines of weakness in the form of inclined grooves, the splitting of the ring segmentally will produce ring segment having mating surfaces which tend to key together without any misalignment. This contrasts with the situation where the mating surfaces are both aligned with each other and with the longitudinal axis of the ring in which case there is no “centring” effect and there is a tendency to have at least some degree of misalignment when the segments are brought together.

Accordingly, the present invention allows the parts of a split seal face ring to be brought together in accurate alignment when access is restricted as occurs in situations where mechanical seals are being used.

### BRIEF DESCRIPTION OF THE DRAWING FIGURES

The invention will now be described, by way of example only, with reference to the accompanying drawing which are as follows:

FIG. 1 is a top plan view of a seal face ring in accordance with the invention;

FIG. 2 is a side elevation of the ring of FIG. 1;

FIG. 3 is a view on the line CC of FIG. 1 and,

FIG. 4 is a view on lines DD of FIG. 1.

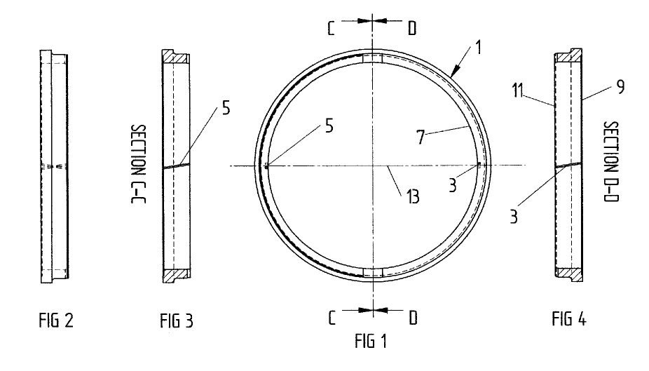

### DETAILED DESCRIPTION OF THE DRAWING FIGURES

Referring to the accompanying drawings, a seal face ring is for use with a split mechanical seal such as is disclosed in U.S. Pat. No. 3,101,200. Ring 1 is made of silicone carbide and has a very fine grain structure. Ring 1 is provided with diametrically opposite grooves 3, 5, which extend along the internal circumferential surface 7 of ring 1 from one longitudinal edge 9 to the other 11. As can best be seen from FIGS. 3 and 4, the grooves 3 and 5 are inclined slightly to the longitudinal plane 13 passing through the centre of ring 1 and through the centres of grooves 3 and 5. As illustrated grooves 3 and 5 are inclined in opposite directions and each at an angle of approximately 5° to the plane 13.

For use in a split mechanical seal, ring 1 is broken about the lines of weakening provided by grooves 3 and 5 to provide two semi-circular segments which can be assembled together within a mechanical seal mounted around, for instance, a pump drive shaft. Because of the oppositely inclined mating faces resulting from the breakage of ring 1, the two segments tend to have a self centring effect when brought together. In this way misalignment of the two segments is easily avoided.

What is claimed is:

1. A seal face ring for use with a split mechanical seal, comprising:
a seal face ring having diametrically opposed grooves along at least a portion of a surface of said seal face ring, said grooves providing lines of weakness for splitting said seal face ring segmentally, said grooves being inclined relative to each other.

2. The seal face ring according to claim 1, wherein said grooves have an inclination in a longitudinal direction.

3. The seal face ring according to claim 1, wherein said grooves are inclined relative to a longitudinal axis of said seal face ring.

4. The seal face ring according to claim 1, wherein said grooves are inclined in opposite directions relative to a longitudinal axis.

5. The seal face ring according to claim 1, wherein said grooves extend along at least an inner circumferential surface of said seal face ring.

6. The seal face ring according to claim 1, wherein each said groove is inclined at angle of up to 10° relative to a longitudinal axis.

7. The seal face ring according to claim 6, wherein each said groove is inclined at an angle of at least 2.5° relative to the longitudinal axis.
